(19) United States
(12) Patent Application Publication
(10) Pub. No.: US 2023/0245292 A1
(43) Pub. Date: Aug. 3, 2023

(54) DEFECT DETECTION BASED ON SELF-SUPERVISED LEARNING

(71) Applicant: LEAN AI TECHNOLOGIES LTD., Tel Aviv (IL)

(72) Inventor: Shimon Cohen, Ness Ziona (IL)

(73) Assignee: LEAN AI TECHNOLOGIES LTD., Tel Aviv (IL)

(21) Appl. No.: 18/163,224

(22) Filed: Feb. 1, 2023

Related U.S. Application Data
(60) Provisional application No. 63/267,482, filed on Feb. 2, 2022.

(51) Int. Cl. G06T 7/00; G06T 5/00; G06T 7/11; G06T 3/40; G06T 3/60

(52) U.S. Cl. CPC G06T 7/0002; G06T 3/40; G06T 3/60; G06T 5/006; G06T 7/11; G06T 2207/20081; G06T 2207/20084; G06T 2207/20224

(57) ABSTRACT

There may be provided a method for defect detection, the method may include (a) receiving an image of an evaluated object; (b) applying a distortion removal machine learning process on the image to provide a processed image of the evaluated object; (c) comparing the image to the processed image to provide a comparison result; and (d) detecting one or more object defects based on the comparison result. The distortion removal machine learning process is trained by a training process to remove distortions from images of objects. The training process includes feeding the machine learning process with images of reference objects and with distorted images of the reference objects. The distorted images are generated by distorting the images of the reference.

### BACKGROUND

Defect detection is a process that involve acquiring images of evaluated objects and processing the images to detect defects. A common method for defect detection include comparing an image of an evaluated object to an image of a reference object. The comparison requires to align the inspected object to the reference object. The alignment may be time and resource consuming – especially when the objects is not flat – and especially when the object is curved.

It may be beneficial to compare the evaluated object to a reference object that is defect free – but generating an image of a defect free reference object may also be time and resource consuming. Comparing the inspected object to an arbitrary reference object may provide ambiguous results – as a different between the evaluated object and the reference object may result from defects of the evaluated object or the reference object.

There is a growing need to provide a cost-effective defect detection process.

### SUMMARY

A method, system and non-transitory computer readable medium for defect detection based on self-supervised learning.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The embodiments of the disclosure will be understood and appreciated more fully from the following detailed description, taken in conjunction with the drawings in which:

FIG. 1 illustrates an example of a method;

FIG. 2 illustrates an example of an image of an object and a background, and an example of a distorted image;

FIG. 3 illustrates an example of an image of an object and a background, and an example of a distorted image;

FIG. 4 illustrates an example of a simplified image of an object and a simplified image of distorted object; and

FIG. 5 illustrates an example of images.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

The specification and/or drawings may refer to an information unit. The information unit may be a sensed information unit. The sensed information unit may capture or may be indicative of a natural signal such as but not limited to signal generated by nature, signal representing human behavior, signal representing operations related to the stock market, a medical signal, audio signal, visual information signal, and the like. Sensed information may be sensed by any type of sensors – such as a visual light camera, or a sensor that may sense infrared, radar imagery, ultrasound, electro-optics, radiography, LIDAR (light detection and ranging), etc.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There may be provide a system, a method, and a non-transitory computer readable medium for defect detection based on self-learning.

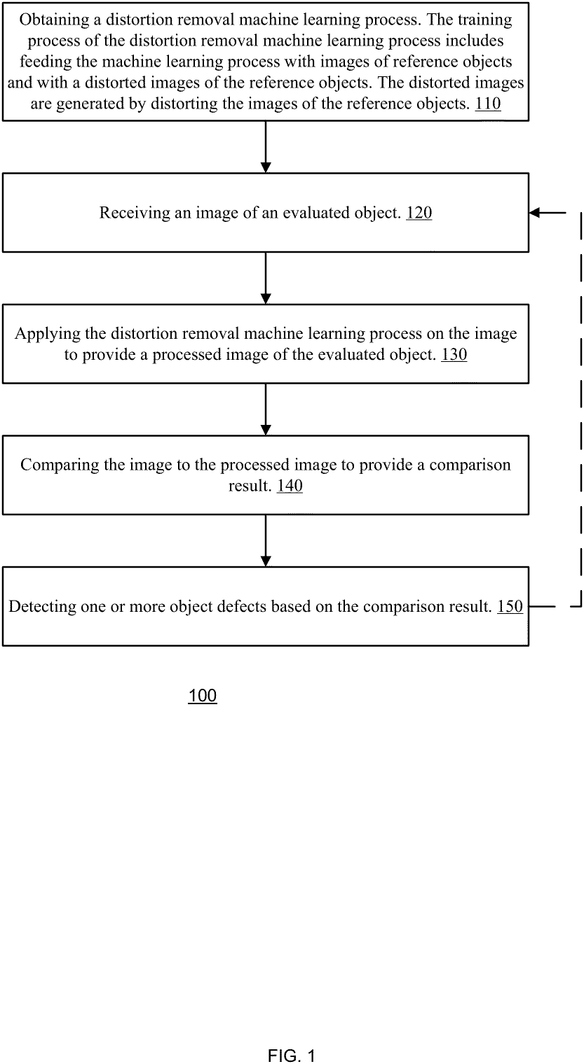

FIG. 1 illustrates an example of a method for defect detection.

Method 100 may start step 110 of obtaining a distortion removal machine learning process.

Step 110 may include at least one out of (a) training the distortion removal machine learning process, or (b) receiving the distortion removal machine learning process.

The distortion removal machine learning process is configured to remove distortions from images of objects. The removal is learned during a training process.

The training process of the distortion removal machine learning process includes feeding the machine learning process with images of reference objects and with distorted images of the reference objects. The distorted images are generated by distorting the images of the reference objects.

The distortions may be of shape and/or size that differ from shape and/or size of defects of inspected objects. For example- they may be smaller than expected defects, may be of different shapes – for example have a polygon shape of circular shape when the expected defects may have a more realistic – flawed shape.

The training process may be a self-supervised process.

The reference objects may be defect free, may include defects or may be or arbitrary defect level.

The training process may include obtaining the distorted images of the reference objects. The obtaining may include generating the distorted images, receiving the distorted images, receiving some distorted images and generating some other distorted images.

An image of a reference object may be distorted multiple times and in multiple manners to provide multiple distorted images.

The distorting of an image of an object may include replacing segments of the image by distorted segments.

A distorted segment is generated by introducing a difference in one or more properties of a corresponding segment of the image.

The one or more properties may include an intensity parameter of the corresponding segment of the image. The intensity parameter may be a gray level parameter such as an average gray level, an average gray level after removal of outliers, a gray level distribution parameter (for example variance, or a sigma of any power), and the like.

The one or more properties may include an average intensity of the corresponding segment of the image. The difference may include mapping the average gray level to another value - the mapping may be a random mapping, a non-random mapping, and the like.

The one or more properties may include a size of an object that appears in the corresponding segment of the image. The segment may be reduced or enlarged by any factor.

The one or more properties may include an orientation of an object that appears in the corresponding segment of the image. The segment may undergo any change in orientation - rotation along any axis- and the like.

The segment may be warped or distorted in any manner.

A segment of an image of an object taken from point of view may be replaced by a segment of the object taken from another point of view.

Step 110 may be followed by step 120 of receiving an image of an evaluated obj ect.

Step 120 may be followed by step 130 of applying the distortion removal machine learning process on the image to provide a processed image of the evaluated object.

The evaluated object may be ideally identical to the reference objects on which the distortion removal machine learning process was trained.

The evaluated object may differ from the reference objects on which the distortion removal machine learning process was trained.

Step 130 may be followed by step 140 of comparing the image to the processed image to provide a comparison result.

Step 140 may include generating a difference image.

Step 140 may be followed by step 150 of detecting one or more object defects based on the comparison result.

Step 130 of applying of the distortion removal machine learning process on the image maintains an orientation and a location of the evaluated object within the distorted image.

Steps 120, 130, 140 and 150 may be executed without alignment of image. This is highly beneficial when the evaluated object is not flat (or have at least a non-flat lower surface, or have multiple facets on which the object may be positioned, or may rotate or otherwise may be positioned or oriented at the inspection site at different manners). This is also beneficial when the evaluated object has a single flat surface - but may be misaligned with a reference object.

Steps 120-150 may be repeated multiple times for multiple images.

Method 100 may include pre-processing the image of the evaluated object to provide a pre-processed image. This include applying a pre-processing operation that differs from the processing of step 130.

Method 100 may also include pre-processing the processed image (output of step 130) to provide a dual-processed image.

Step 140 may include comparing between the pre-processed image and the dual processed image to provide the comparison result.

The pre-processed image may provide information about one or more features of the image. The features may be gradients or any other feature. The pre-processed image may be a gradient image of the processed image. Gradients may be calculated in relation to any direction or by applying any gradient kernel. The same is applied, mutatis mutandis, to the dual-processed image.

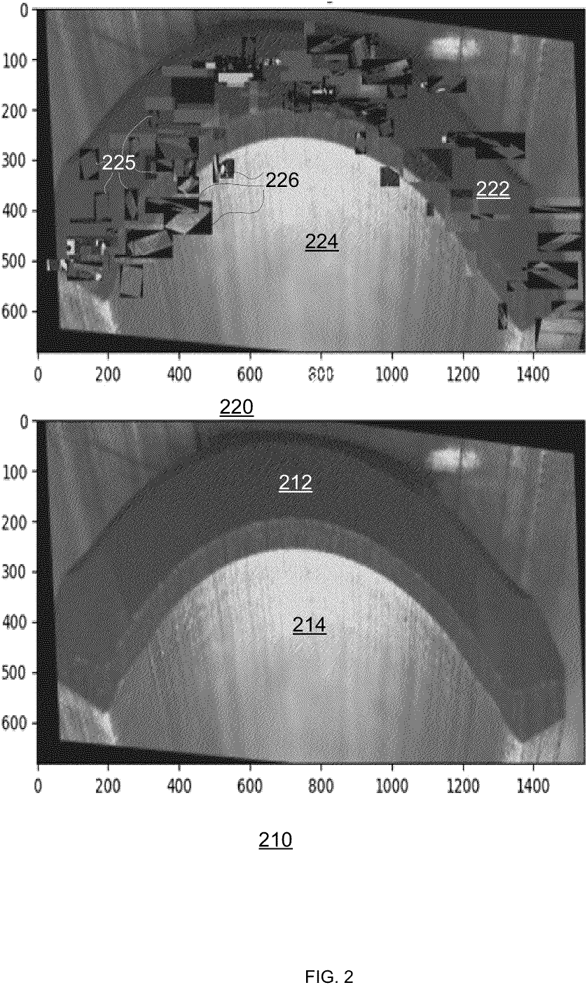

FIG. 2 illustrates an example of an image 210 of an object 212 and a background 214, and an example of a distorted image 220 that includes a distorted object 222 and a distorted background 224. Image 210 and distorted image 220 are fed to a self-learning machine learning process. The distortion of the object is denoted 225. The distortions of the background are denoted 226. The background may or may not be distorted. There may be distortions that span along the background and the object.

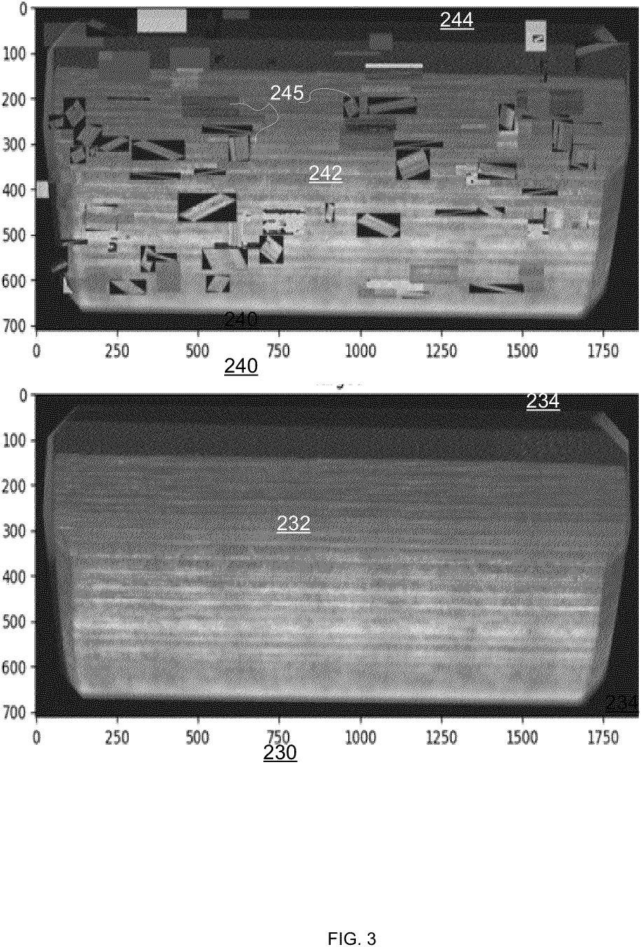

FIG. 3 illustrates an example of an image 230 of an object 232 and a background 234, and an example of a distorted image 240 that includes a distorted object 242 and a distorted background 244. Image 230 and distorted image 240 are fed to a self-learning machine learning process. The distortion of the object are denoted 245. The background may or may not be distorted. There may be distortions that span along the background and the obj ect.

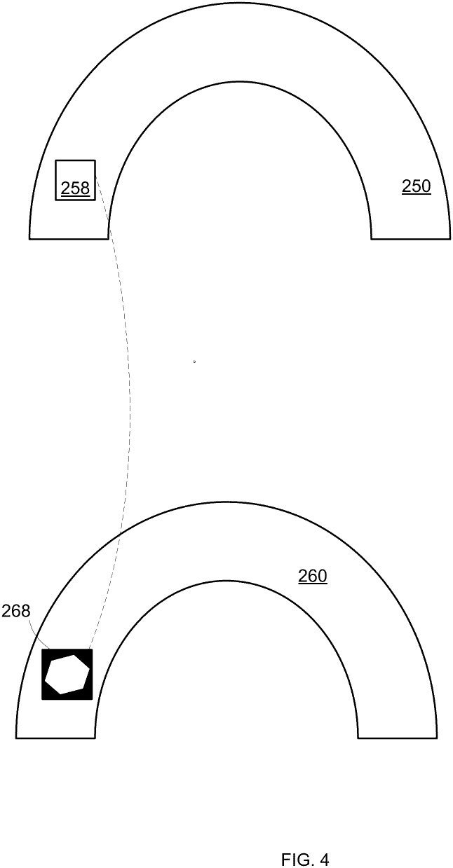

FIG. 4 illustrates an example of a simplified image of object 250 having a portion 258 of an object, and a simplified image of distorted object 260 having a distorted portion 268. Portion 258 was distorted by changing the gray level values and converting a while square of a certain size to a larger square that includes an oriented hexagon that is surrounded by a black square.

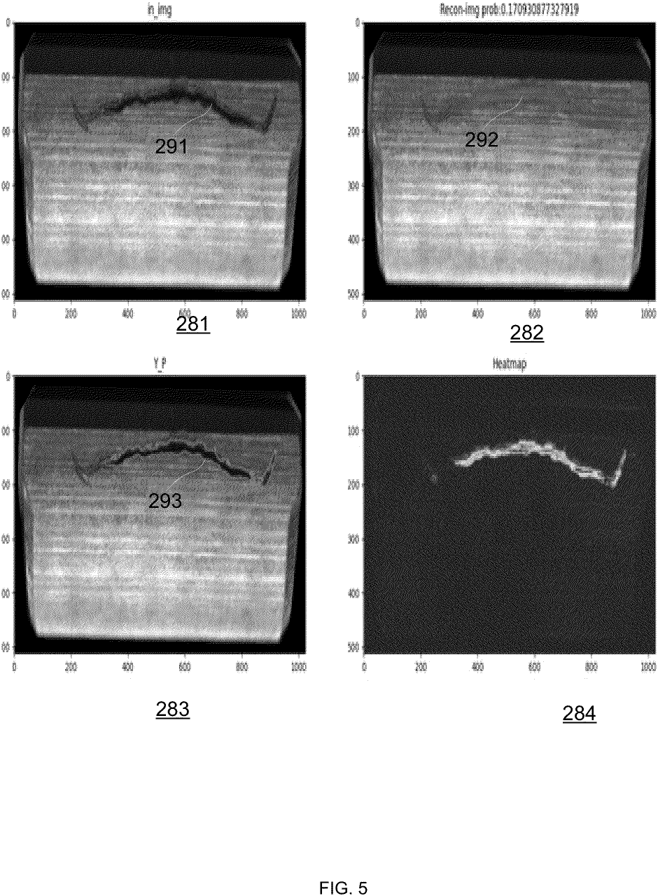

FIG. 5 illustrates an example of an acquired image 281, a processed image of the evaluated object (outputted from a distortion removal machine learning process) 282, a difference image 283 and a heat map 284. The acquired image illustrates an object with a defect 291, the defect is barely seen (see 292) in the processed image, a difference image in which the defect is clearly visible (see 293) - as also illustrated by heat map 284.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system and any other component should be applied mutatis mutandis to a method that may be executed by a system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any combination of any module or unit listed in any of the figures, any part of the specification and/or any claims may be provided. Especially any combination of any claimed feature may be provided.

Any reference to the term “comprising” or “having” should be interpreted also as referring to “consisting” of “essentially consisting of”. For example – a method that comprises certain steps can include additional steps, can be limited to the certain steps or may include additional steps that do not materially affect the basic and novel characteristics of the method – respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on non-transitory computer readable media permanently, removably or remotely coupled to an information processing system. The non-transitory computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for defect detection, the method comprises:
receiving an image of an evaluated object;
applying a distortion removal machine learning process on the image to provide a processed image of the evaluated object;
comparing the image to the processed image to provide a comparison result; and
detecting one or more object defects based on the comparison result;
wherein the distortion removal machine learning process is trained by a training process to remove distortions from images of objects; and
wherein the training process comprises feeding the machine learning process with images of reference objects and with distorted images of the reference objects; wherein the distorted images are generated by distorting the images of the reference.

2. The method according to claim 1 wherein a distorting of an image of a defect
free object comprises replacing segments of the image by distorted segments;
wherein a distorted segment is generated by introducing a difference in one or more properties of a corresponding segment of the image.

3. The method according to claim 2 wherein the one or more properties comprises an intensity parameter of the corresponding segment of the image.

4. The method according to claim 2 wherein the one or more properties comprises an average intensity of the corresponding segment of the image.

5. The method according to claim 2 wherein the one or more properties comprises a size of an item that appears in the corresponding segment of the image.

6. The method according to claim 2 wherein the one or more properties comprises an orientation of an item that appears in the corresponding segment of the image.

7. The method according to claim 1 wherein the applying of the distortion removal machine learning process on the image maintains an orientation and a location of the evaluated object within the distorted image.

8. The method according to claim 1 wherein the applying, comparing and generating are executed without alignment of image.

9. The method according to claim 1 wherein the comparing comprises generating a difference image.

10. The method according to claim 1 wherein the training process is a self-supervised training process.

11. The method according to claim 1 wherein the images of reference objects are images of defect free reference objects.

12. A non-transitory computer readable medium for defect detection, the non-transitory computer readable medium stores instructions for:
receiving an image of an evaluated object;
applying a distortion removal machine learning process on the image to provide a processed image of the evaluated object;
comparing the image to the processed image to provide a comparison result; and
detecting one or more object defects based on the comparison result;
wherein the distortion removal machine learning process is trained by a training process to remove distortions from images of objects; and
wherein the training process comprises feeding the machine learning process with images of reference objects and with distorted images of the reference objects; wherein the distorted images are generated by distorting the images of the reference.

13. The non-transitory computer readable medium according to claim 13 wherein a distorting of an image of a defect free object comprises replacing segments of the image by distorted segments; wherein a distorted segment is generated by introducing a difference in one or more properties of a corresponding segment of the image.

14. The non-transitory computer readable medium according to claim 13 wherein the applying of the distortion removal machine learning process on the image maintains an orientation and a location of the evaluated object within the distorted image.

15. The non-transitory computer readable medium according to claim 13 wherein the applying, comparing and generating are executed without alignment of image.

16. The non-transitory computer readable medium according to claim 13 wherein the comparing comprises generating a difference image.

17. The non-transitory computer readable medium according to claim 13 wherein the training process is a self-supervised training process.

18. The non-transitory computer readable medium according to claim 13 wherein the images of reference objects are images of defect free reference objects.

19. A system for semi-supervised learning via different modalities, the system comprises a neural network processor that is configured to: receiving an image of an evaluated object;
applying a distortion removal machine learning process on the image to provide a processed image of the evaluated object;
comparing the image to the processed image to provide a comparison result; and
detecting one or more object defects based on the comparison result;
wherein the distortion removal machine learning process is trained by a training process to remove distortions from images of objects; and
wherein the training process comprises feeding the machine learning process with images of reference objects and with a distorted images of the reference objects; wherein the distorted images are generated by distorting the images of the reference.
